(19) United States
(12) Patent Application Publication
(10) Pub. No.: US 2021/0114148 A1
(43) Pub. Date: Apr. 22, 2021

(54) FLUX FOR SUBMERGED ARC WELDING

(71) Applicant: Kabushiki Kaisha Kobe Seiko Sho (Kobe Steel, Ltd.), Kobe-shi (JP)

(72) Inventors: Daisuke HATOMOTO, Kanagawa (JP); Munenobu SATO, Kanagawa (JP)

(73) Assignee: Kabushiki Kaisha Kobe Seiko Sho (Kobe Steel, Ltd.), Kobe-shi (JP)

(21) Appl. No.: 17/040,302

(22) PCT Filed: Mar. 19, 2019
(86) PCT No.: PCT/JP2019/011616

§ 371 Date: Sep. 22, 2020

(30) Foreign Application Priority Data
Mar. 29, 2018 (JP) 2018-064990

(51) Int. Cl. B23K 35/362; B23K 35/36; B23K 35/40

(52) U.S. Cl. CPC B23K 35/362; B23K 35/3605; B23K 35/40; B23K 35/361; B23K 35/3608; B23K 35/3602

(57) ABSTRACT

A flux for submerged arc welding is a sintered flux and is for use in high speed welding. In the flux, the following relationships of contents in mass percent are satisfied: CaF₂: 10.0% to 20.0%, MgO: 8.0% to 15.0%, a sum of Na₂O and K₂O: 2.1% to 3.5%, MnO: 1.5% to 5.0%, FeO: 0.5% to 5.0%, SiO₂: 10.0% to 20.0%, Al₂O₃: 13.0% to 28.0%, and TiO₂: 13.0% to 28.0%. In addition, the following relationships are further satisfied: 65≤(MgO+SiO₂+Al₂O₃+TiO₂)≤75, and 0.5≤(Al₂O₃/TiO₂)≤2.0.

### TECHNICAL FIELD

The present invention relates to a flux for submerged arc welding, specifically to a sintered flux for submerged arc welding for use in high speed welding.

### BACKGROUND ART

Submerged arc welding is a welding method used for pipe-making welding or the like for pipelines through which petroleum, natural gas or the like is transported, and a flux for use in submerged arc welding is generally classified into a fused flux and a sintered flux in terms of its form. The fused flux is produced by melting various raw materials in an electric furnace or the like and crushing the materials, while the sintered flux is produced by bonding various raw materials with a binder such as sodium silicate, granulating them, and thereafter sintering the granulated materials.

The sintered flux is classified, depending on the sintering temperature, into a low-temperature sintered flux (for example, a sintering temperature being 400° C. or higher and lower than 600° C.) and a high-temperature sintered flux (for example, a sintering temperature being 600° C. or higher and 1200° C. or lower).

As such a flux for submerged arc welding, in order to form a good weld metal without a weld defect and to obtain a beautiful bead appearance with good slag removability, Patent Literature 1 discloses a fused flux for submerged arc welding, containing 35% to 45% of MnO and 35% to 45% of SiO₂, and further containing: MnO₂: 0.1% to 1.0%; CaF₂: 1% to 9%; CaO: 0.1% to 8%; MgO: 0.5% to 7%; Al₂O₃: 0.5% to 6%; FeO: 7% or less; with the other being alkali metal oxides and inevitable impurities.

In addition, Patent Literature 2 discloses a flux for submerged arc welding which gives good welding workability irrespective of whether a welding power source is an alternating current type or a direct current type, and gives reduction in moisture absorption amount of the flux and diffusible hydrogen content in a weld metal, the flux for submerged arc welding containing: Al₂O₃: 15 mass % to 35 mass %; SiO₂: 10 mass % to 30 mass %; MgO: 10 mass % to 25 mass %; F in terms of CaF₂ conversion value: 10 mass % to 25 mass %; Mn in terms of MnO conversion value: 3 mass % to 20 mass %; a sum of at least one of Na in terms of Na₂O conversion value, K in terms of K₂O conversion value, and Li in terms of Li₂O conversion value: 0.5 mass % to 6.5 mass %; Fe in terms of FeO conversion value: 0.5 mass % to 8 mass %; CaO: 6 mass % or less; water soluble SiO₂: 1.0 mass % or less; water soluble Na₂O: 1.0 mass % or less; and water soluble K₂O: 0.8 mass % or less, and satisfying the following formula (1):

0.20≤[MgO]/([Al₂O₃]+[MnO])≤0.80 (I),

where [Al₂O₃] is the Al₂O₃ content, [MgO] is the MgO content, and [MnO] is the MnO conversion value of Mn.

### CITATION LIST

### Patent Literature

Patent Literature 1: Japanese Patent No. 4783708

Patent Literature 2: JP-A-2016-140888

### SUMMARY OF INVENTION

### Technical Problem

However, the flux in Patent Literature 1 is a fused flux, and large-expense equipment is required to produce the flux, resulting in barrier to reduction in cost and diffusion of products thereof. In addition, workability in high speed welding is improved by containing 35% to 45% of each of MnO and SiO₂, but when much amount of SiO₂ is contained, basicity of the flux decreases and low-temperature toughness of the weld metal deteriorates.

In addition, as to the flux in Patent Literature 2, in a case of high speed welding using a high current, since a bead shape is convex and welding workability such as slag removability decreases, it is difficult to increase a speed of welding.

Therefore, an object of the present invention is to provide a flux for submerged arc welding which is a sintered flux and gives excellent slag removability, excellent bead shape, and excellent bead appearance in high speed welding using a high current.

### Solution to Problem

As a result of intensive studies, the present inventors have found that the problem can be solved by limiting a component composition of the flux to a specific one, and the present invention has been completed.

That is, a flux for submerged arc welding in an embodiment of the present invention is a flux for submerged arc welding, which is a sintered flux and is for use in high speed welding, and the following relationships of contents in mass percent are satisfied:

CaF₂: 10.0% to 20.0%;

MgO: 8.0% to 15.0%;

a sum of Na₂O and K₂O: 2.1% to 3.5%;

MnO: 1.5% to 5.0%;

FeO: 0.5% to 5.0%;

SiO₂: 10.0% to 20.0%;

Al₂O₃: 13.0% to 28.0%; and

TiO₂: 13.0% to 28.0%, and

the following relationships are further satisfied:

65≤(MgO+SiO₂+Al₂O₃+TiO₂)≤75; and

0.5≤(Al₂O₃/TiO₂)≤2.0.

In the flux for submerged arc welding in an embodiment of the present invention, at least one of the following relationships of contents in mass percent is further satisfied:

CaO: 0.2% to 3.0%;

ZrO₂: 5% or less (including 0%); and

B₂O₃: 0.03% to 0.15%.

The flux for submerged arc welding in an embodiment of the present invention is a high-temperature sintered flux sintered at 700° C. to 1200° C.

### Advantageous Effects of Invention

In the present invention, even in high speed submerged arc welding where a welding speed is about 60 cm/min in one-electrode welding and is about 200 cm/min in two-electrode welding, a welded portion good in the slag removability and excellent in the bead shape and appearance can be obtained. Furthermore, a welded portion which is excellent in porosity defect resistance and has little deterioration in low temperature toughness can be obtained.

### BRIEF DESCRIPTION OF DRAWINGS

FIG. 1 is a schematic view of an electrode arrangement during welding in Examples and Comparative Examples.

### DESCRIPTION OF EMBODIMENTS

Hereinafter, embodiments for carrying out the present invention are described in detail. The present invention is not limited to embodiments described below. In the present description, “to” indicating a numerical range is used as a meaning including numerical values before and after “to” as the lower limit and the upper limit value.

### <Flux for Submerged Arc Welding>

The flux for submerged arc welding in the present embodiment (hereinafter simply referred to as “flux” in some cases) is a sintered flux for use in high speed welding, and the following relationships of contents in mass percent are satisfied: CaF₂: 10.0 to 20.0%; MgO: 8.0% to 15.0%; a sum of Na₂O and K₂O: 2.1% to 3.5%; MnO: 1.5% to 5.0%; FeO: 0.5% to 5.0%; SiO₂: 10.0% to 20.0%; Al₂O₃: 13.0% to 28.0%, and TiO₂: 13.0% to 28.0%, and the following relationships are satisfied: 65≤(MgO+SiO₂+Al₂O₃+TiO₂)≤75; and 0.5≤(Al₂O₃/TiO₂)≤2.0.

In the flux in the present embodiment, at least one of the following contents in mass percent may be further satisfied: CaO: 0.2% to 3.0%; ZrO₂: 5% or less (including 0%); and B₂O₃: 0.03% to 0.15%, and the flux may be a high-temperature sintered flux sintered at 700° C. to 1200° C.

Here, in the present embodiment, the high speed welding is welding performed at a speed of 600 mm/min or more in a case of one electrode or two electrodes and is welding performed at a speed of 1000 mm/min or more in a case of three electrodes or four electrodes.

### (Component Composition)

A content (mass percent) of each component in the flux of the present embodiment is described below. The content of each component in the flux of the present embodiment is a converted value obtained by converting a value quantified by the method defined in JIS Z 3352: 2010 into an oxide thereof or fluoride thereof, unless otherwise specified. The content of each component is a content per the entire flux.

CaF₂ (CaF₂ Conversion Value of Fluoride): 10.0% to 20.0%

A fluoride has an effect of enhancing electrical conductivity and fluidity of molten slag and is one of components that affect high temperature viscosity of the molten slag. This action is proportional to a content of CaF₂, similarly to the case of CaO described later. In the case where the content of CaF₂ is too small, the slag is immediately solidified to hinder discharge of gas, or slag seizure occurs. Therefore, in order to improve slag removability and prevent occurrence of slag seizure, the content of CaF₂ is 10.0% or more, preferably 15.0% or more, in terms of CaF₂ conversion value of a fluoride. Further, the content of CaF₂ is 20.0% or less, preferably 19.0% or less, in order to prevent the bead appearance from deteriorating due to rough bead ripples and to improve the bead shape.

The content of CaF₂ (CaF₂ conversion value of fluoride) is a value obtained by converting a total amount of F in the flux obtained by analysis using a method (for example, JIS K 1468-2:1999) defined in JIS Z 3352: 2010 into CaF₂. In addition, the fluoride component in the flux of the present embodiment is mainly CaF₂, and AlF₃, MgF₂, or the like may be contained, but when the content of CaF₂ (CaF₂ conversion value of fluoride) is within the range described above, the effect of fluoride described above is not affected.

### MgO (MgO Conversion Value of Mg and Mg Oxide): 8.0% to 15.0%

MgO is a component that greatly contributes to improvement of slag removability and is an essential component to ensure good slag removability and prevent slag seizure regardless of the mode of a welding power supply. Therefore, the content of MgO is 8.0% or more, preferably 10.0% or less, in terms of MgO conversion value of Mg and an Mg oxide. In order to prevent the bead shape from becoming convex and to maintain good slag removability, the content of MgO is 15.0% or less, preferably 14.0% or less.

The content of MgO referred to here is a value obtained by converting a total amount of Mg in the flux obtained by analysis using a method (for example, JIS M 8222:1997) defined in JIS Z 3352:2010 into MgO.

Sum of Na₂O and K₂O (sum of Na₂O conversion value of Na and Na oxide and K₂O conversion value of K and K oxide): 2.1% to 3.5% Na and K, which are alkali metals, are components that mainly affect arc stability during welding and hygroscopic properties of the flux, and are mainly added in a form of oxides such as Na₂O and K₂O. In order to obtain good arc stability, a total content of Na₂O and K₂O is 2.1% or more, preferably 2.5% or more, in terms of a sum of Na₂O conversion value of Na and a Na oxide and K₂O conversion value of K and a K oxide. In addition, in order to obtain good moisture absorption resistance, the total content of Na₂O and K₂O is 3.5% or less, preferably 3.0% or less.

Incorporation of at least one of Na and K into the flux of the present embodiment is sufficient.

The total content of Na₂O and K₂O referred to here is a value obtained by converting a total amount of Na and total amount of K in the flux, the total amount of each of Na and K being obtained by analysis using a method (for example, JIS M 8852:1998) defined in JIS Z 3352:2010, into Na₂O and K₂O, respectively. The Na component and the K component in the flux of the present embodiment are mainly Na₂O and K₂O, respectively, but may also contain NaAlSi₃O₈, KAlSi₃O₈, or the like. Na and K here are derived from an ore raw material and water glass.

### MnO (MnO Conversion Value of Mn and Mn Oxide): 1.5% to 5.0%

Mn is a component that affects viscosity and solidification temperature of the molten slag and is effective to improve the pockmark resistance, and is mainly added in a form of oxides such as MnO, MnO₂, and Mn₂O₃. Among various forms, in the case where Mn is added in a form of manganese monoxide (MnO), the above effect is particularly obtained. In order to achieve good low-temperature toughness and prevent occurrence of porosity defects, the content of MnO is 1.5% or more, preferably 2.0% or more, in terms of MnO conversion value of Mn and a Mn oxide. On the other hand, in order to prevent deterioration of mechanical properties due to an increase in the oxygen amount in the molten metal, to reduce occurrence of slag seizure, and to obtain a good bead shape and slag removability, the content of MnO is 5.0% or less, preferably 3.0% or less, and more preferably 2.5% or less.

The content of MnO referred to here is a value obtained by converting a total amount of Mn in the flux obtained by analysis using a method (for example, JIS M 8232:2005) defined in JIS Z 3352:2010 into MnO.

### FeO (FeO Conversion Value of Fe and Fe Oxide): 0.5% to 5.0%

Fe has an effect of promoting a deoxidization phenomenon and improving the pockmark resistance and is mainly added in a form of a metal powder such as Fe—Si. Since the effect described above is proportional to a presence amount of Fe, in particular, in order to obtain a sufficient effect in the case where a welding power source is a direct current, the content of FeO is 0.5% or more, in terms of FeO conversion value of Fe and a Fe oxide, and is preferably 1.0% or more, more preferably 1.5% or more, and still more preferably 2.5% or more, from the standpoint of pockmark resistance. On the other hand, in order to affect a solidification temperature of slag and to prevent deterioration of the bead appearance, the bead shape, and slag removability, the content of FeO is 5.0% or less, preferably 4.5% or less.

The content of FeO referred to here is a value obtained by converting a total amount of Fe in the flux obtained by analysis using a method (for example, JIS M 8202:2000) defined in JIS Z 3352: 2010 into FeO, and in addition to Fe added as metal powder, FeO, Fe₂O₃, Fe₃O₄, or the like may be contained.

### SiO₂: 10.0% to 20.0%

SiO₂ has an effect of mainly improving the bead appearance and bead shape by giving a moderate viscosity to the molten slag. In order to prevent deterioration of the bead appearance and bead shape due to a decrease in viscosity of the molten slag, the content of SiO₂ is 10.0% or more, preferably 17.0% or more. On the other hand, since excessive content of SiO₂ causes deterioration of the bead shape, slag removability, and toughness, the content of SiO₂ is 20.0% or less, preferably 19.0% or less.

The content of SiO₂ referred to here is a value obtained by converting a total amount of Si in the flux obtained by analysis using a method (for example, JIS M 8214:1995) defined in JIS Z 3352: 2010 into SiO₂.

Al₂O₃(Al₂O₃Conversion Value of Al and Al Oxide): 13.0% to 28.0%

Al₂O₃ is a component that gives removability of the molten slag and the low-temperature toughness and has an effect of improving the bead shape during welding. In order to realize a good bead shape or bead ripple, the content of Al₂O₃ is 13.0% or more, preferably 20.0% or more, in terms of Al₂O₃ conversion value of Al and an Al oxide. On the other hand, in order to prevent slag removability at a bead end from deteriorating due to excessive increase of a melting point of the molten slag, the content of Al₂O₃ is 28.0% or less, more preferably 27.0% or less.

The content of Al₂O₃ referred to here is a value obtained by converting a total amount of Al in the flux obtained by analysis using a method (for example, JIS M 8220:1995) defined in JIS Z 3352:2010 into Al₂O₃.

TiO₂ (TiO₂ Conversion Value of Ti and Ti Oxide): 13.0% to 28.0%

TiO₂ is a component that gives removability of the molten slag and the low-temperature toughness and has an effect of improving the bead shape during welding. In order to realize the good bead shape or bead ripple and to prevent the deterioration of the low-temperature toughness, the content of TiO₂ is 13.0% or more, preferably 15.0% or more, in terms of TiO₂ conversion value of Ti and a Ti oxide. On the other hand, in order to prevent slag removability at a bead end from deteriorating due to excessive increase of a melting point of the molten slag, the content of TiO₂ is 28.0% or less, preferably 24.0% or less.

The content of TiO₂ referred to here is a value obtained by converting a total amount of Ti in the flux obtained by analysis using a method (for example, JIS M 8219:2012) defined in JIS Z 3352: 2010 into TiO₂.

Among the components described above, a total content of MgO, SiO₂, Al₂O₃, and TiO₂, i.e. (MgO+SiO₂+Al₂O₃+TiO₂), is 65% or more, preferably 67% or more, in order to obtain good slag removability. On the other hand, MgO+SiO₂+Al₂O₃+TiO₂ is 75% or less, preferably 73% or less, in order to prevent deterioration of the bead shape.

A ratio of the content of Al₂O₃ to the content of TiO₂, i.e. (Al₂O₃/TiO₂), is 0.5 or more, preferably 1.0 or more, in order to prevent deterioration of the bead shape or bead ripple. On the other hand, Al₂O₃/TiO₂ is 2.0 or less, preferably 1.5 or less, in order to prevent deterioration of slag removability and occurrence of slag seizure.

In the flux of the present embodiment, in addition to the components described above, it is preferred that at least one of the following relationships of contents in mass percent is further satisfied: CaO: 0.2% to 3.0%; ZrO₂: 5% or less (including 0%); and B₂O₃: 0.03% to 0.15%.

### CaO: 0.2% to 3.0%

In addition to the above components, the flux of the present embodiment may contain CaO.

CaO is a component that increases basicity of the slag to increase cleanliness of the weld metal and also affects fluidity of the molten slag, and the effect is obtained in proportion to the presence amount. In order to reduce fluidity of the molten slag and further improve the bead appearance and shape, the content of CaO is preferably 3.0% or less. On the other hand, the lower limit of the content of CaO is not particularly limited, and the content of CaO is preferably 0.2% or more from the viewpoint of improvement of cleanliness of the weld metal.

The flux of the present embodiment contains the above-mentioned CaF₂ in addition to CaO as a Ca component. Therefore, the content of CaO referred to here is a converted value determined from a total amount of Ca and a total amount of F obtained by analysis using a method defined in JIS Z 3352:2010. Therefore, in the case where the content of CaF₂ is large, the content of CaO may be 0 in accordance with JIS Z 3352:2010.

### ZrO₂: 5.0% or Less (Including 0%)

ZrO₂ is an extremely important component to affect the viscosity and solidification temperature of the molten slag and to obtain arc stability in high speed welding, good bead shape and bead appearance, and good slag removability. The flux of the present embodiment may not contain ZrO₂, but in the case where ZrO₂ is contained, the content thereof is preferably 0.4 mass % or more. In order to prevent deterioration of the slag removability and bead shape, the content of ZrO₂ is preferably 5.0% or less, more preferably 1.0% or less. Here, the content of ZrO₂ is obtained by converting a total amount of Zr contained in the flux into ZrO₂, and is analyzed in accordance with, for example, JIS R 2216:2005.

B₂O₃: 0.03% to 0.15%

In addition to the above components, the flux of the present embodiment may contain B₂O₃ using boron oxide, borax, or the like as raw material. B₂O₃ is a component effective to improve toughness of the molten metal, and the content thereof is preferably 0.03% or more in order to prevent deterioration of the low-temperature toughness of the molten metal. On the other hand, excessive amount of B₂O₃ may cause hardening of the molten metal to lead to hot crack and decrease in toughness, the content of B₂O₃ is preferably 0.15% or less.

In addition to satisfying of the above component composition, the flux of the present embodiment is preferably a high-temperature sintered flux sintered at 700° C. to 1200° C. in order to reduce moisture in the flux and to improve the porosity defect resistance. The sintering temperature is more preferably 800° C. or higher.

The high-temperature sintered flux can also be determined by a content of water-soluble SiO₂ in the flux. In general, the content of water-soluble SiO₂ in the flux sintered at 800° C. or higher is less than 1.0%.

The water-soluble SiO₂ is mainly derived from a binder such as water glass, and in order to reduce the content of SiO₂, it is effective to sinter the flux at not less than the temperature at which the binder changes to be water insoluble. Specifically, the sintering temperature is preferably 700° C. or higher, more preferably 800° C. or higher. The content of water-soluble SiO₂ can be controlled mainly by adjusting the sintering temperature.

The content of the water-soluble SiO₂ in the flux can be measured by the following method. First, the flux is pulverized to have a particle diameter of 300 μm or less with a vibration mill, and about 0.2 g of a measurement sample is collected therefrom (step 1). Next, the measurement sample and 100 ml of distilled water are put in a quartz Erlenmeyer flask, and a soluble component is extracted under boiling over 4 hours (step 2). Then, after the extract is left for 12 hours or more, precipitates and suspended matter in the extract are removed, and Si is quantified by an absorptiometric method (step 3).

Here, the content of water-soluble SiO₂ is a value obtained by converting a total amount of Si in the flux obtained by analysis using the method described above into SiO₂, and the content thereof is specified distinctly from the total content of SiO₂ described above.

Other than the above components, components contained in the flux are inevitable impurities such as Ba, Li, P, and S. Among these inevitable impurities, the content of each of Ba, Li, and the like is preferably regulated to 1.0% or less, and the content of each of P and S that particularly affect welding quality is preferably regulated to 0.05% or less. In addition, the total content of Ba, Li, P, S, and the like is preferably 3% or less.

### (Production Method)

For producing the flux of the present embodiment, for example, raw material powders are blended to have the composition described above, kneaded with a binder, and then granulated and sintered. At this time, for example, sodium silicate can be used as the binder. A granulation method is not particularly limited, and a method using a rolling granulator or an extrusion granulator is preferable.

Sintering after granulation can be performed with a rotary kiln, a stationary batch furnace, a belt sintering furnace, or the like. The sintering temperature at that time is preferably 700° C. or higher, and more preferably 800° C. or higher, in order to change the binder to be water-insoluble as described above. The upper limit thereof is not particularly limited, and the sintering temperature is generally 1200° C. or lower.

As described above in detail, the flux in the present embodiment can give good slag removability, good bead shape, and good bead appearance in high speed welding since the content of each component is defined in a specific range and the specific relationship is satisfied. Furthermore, a welded portion which is excellent in porosity defect resistance and has little deterioration in low-temperature toughness can be obtained.

In thin plate high speed submerged arc welding or spiral welding, welding with one electrode or two electrodes is frequently performed, and in welding for pipe making, welding with two electrodes to four electrodes is performed. Further, as a welding speed increases, the bead appearance or slag removability easily deteriorates and porosity defects such as blowholes easily occur, and in high speed submerged arc welding with a high current, mechanical properties of the weld metal, particularly toughness, easily deteriorate. In contrast, even if high speed submerged arc welding is performed at a speed of about 60 cm/min in the case of one-electrode welding and is performed at a speed of about 200 cm/min in the case of two-electrode welding, the above effect can be obtained by using the flux in the present embodiment.

### (Welding Conditions)

Examples of conditions of one-electrode welding using the flux in the present embodiment include the following conditions, but the present invention is not limited to the following conditions. “1st” means welding on a front surface side of a steel plate, and “2nd” means welding on a back surface side of the steel plate.

Polarity: DCEP,

Welding current: 400 A to 700 A (1st), 600 A to 850 A (2nd),

Arc voltage: 26 V to 34 V (1st), 28 V to 36 V (2nd),

Welding speed: 60 cm/min to 150 cm/min (1st, 2nd),

Steel kind: mild steel to high tension steel (590 MPa),

Plate thickness: 9 mm to 20 mm,

Electrode extension: 15 mm to 45 mm.

Examples of conditions of two-electrode welding using the flux in the present embodiment include the following conditions, but the present invention is not limited to the following conditions.

Welding current/arc voltage: 800 A to 1200 A/26 V to 34 V (1st, L pole (DC)), 450 A to 850 A/30 V to 38 V (1st, T pole (AC)), 1000 A to 1500 A/26 V to 34 V (2nd, L pole), 450 A to 850 A/30 V to 38 V (2nd, T pole),

Welding speed: 100 cm/min to 400 cm/min (1st, 2nd),

Electrode arrangement: An angle formed between the L pole and T pole is 10° to 45°, and downward inclination is 0 to 6°,

Steel kind: mild steel to high tension steel (590 MPa).

### EXAMPLES

Hereinafter, the present embodiment is described in more detail by referring to Examples, but the present invention is not limited to these Examples, and can be carried out with changes within the scope of the present invention, all of which are included in the technical scope of the present invention.

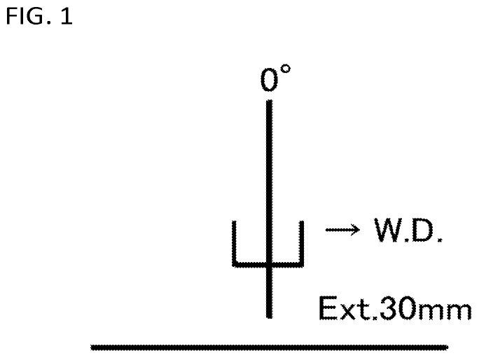

A wire having a chemical composition including, in mass %, C: 0.10% to 0.20%, Si: 0.01% to 0.10%, Mn: 1.70% to 2.20%, P: 0.03% or less, S: 0.03% or less was used to perform high speed submerged arc welding using fluxes shown in Tables 1 and 2 under the following welding conditions with an electrode arrangement shown in FIG. 1.

Polarity: DCEP,

Welding current: 550 A (1st), 750 A (2nd),

Arc voltage: 30 V (1st), 32 V (2nd),

Welding speed: 60 cm/min (1st, 2nd),

Heat input: 16.5 kJ/cm (1st), 24.0 kJ/cm (2nd),

Steel kind: mild steel to high tension steel (590 MPa),

Plate thickness: 12 mm,

Electrode extension: 30 mm.

### <Evaluation Method>

A bead appearance, bead shape, slag removability, porosity defect resistance, and low-temperature toughness of the obtained welded portion were evaluated. The results are shown in Tables 3 and 4, and it was taken as passed that all of these evaluation results were “∘”.

### (Bead Appearance)

The bead appearance was mainly evaluated by ripple and luster of the bead, and the evaluation was performed by visually observing the welded portion. As a result, the case where there was no disorder in the bead ripple and there was metallic luster in the bead was evaluated as “o”, the case where the bead ripple was meandering was evaluated as “Δ”, and the case where the bead end was uneven was evaluated as “x”.

### (Bead Shape)

The bead shape was mainly evaluated by unevenness of the bead and shape of the bead on a base metal, and the evaluation was performed by visually observing the welded portion. As a result, the case of a bead having a weld reinforcement height of less than 4 mm was evaluated as “o”, and the case of a bead having a weld reinforcement height of 4 mm or more was evaluated as “x”.

### (Slag Removability)

The slag removability was evaluated by easiness of slag removal and presence or absence of seizure. Specifically, the case where the slag was spontaneously removed without seizure was evaluated as “∘”, the case where a part of the slag was not spontaneously removed and seizure occurred was evaluated as “Δ”, and the case where the slag was not spontaneously removed over the whole surface and seizure occurred was evaluated as “x”.

### (Porosity Defect Resistance)

The porosity defect resistance was evaluated by a pockmark occurrence rate. The case where no pockmark occurred was evaluated as “∘”, the case where one or two pockmarks occurred per unit welding length (20 cm) was evaluated as “s”, and the case where at least three pockmarks occurred per unit welding length (20 cm) was evaluated as “x”.

### (Low-Temperature Toughness)

The low temperature toughness was measured after producing an all-weld metal. An impact value at −20° C. was measured by a Charpy impact test under the test conditions in accordance with JIS Z 3118:2007. The case where the impact value was 47 J or more was evaluated as “∘”, the where the impact value was 27 J or more and less than 47 J was evaluated as “Δ”, and the case where the impact value was less than 27 J was evaluated as “x”.

TABLE 1

| | Component composition (mass %) | | | | | | | | | | | | | |
|---|---|---|---|---|---|---|---|---|---|---|---|---|---|---|
| | | | | | | | | | | | | | MgO + SiO₂ + | Al₂O₃/ |
| | CaO | CaF₂ | MgO | Na₂O | K₂O | MnO | FeO | SiO₂ | Al₂O₃ | TiO₂ | ZrO₂ | B₂O₃ | Al₂O₃ + TiO₂ | TiO₂ |
| Example 1 | 0.4 | 17.8 | 12.5 | 1.9 | 1.0 | 2.1 | 3.9 | 17.7 | 20.7 | 21.1 | 0.2 | 0.10 | 72.00 | 0.98 |
| Example 2 | 0.3 | 18.5 | 13.3 | 1.9 | 0.8 | 2.0 | 3.8 | 16.9 | 23.8 | 17.7 | 0.2 | 0.11 | 71.70 | 1.34 |
| Example 3 | 1.5 | 19.5 | 9.4 | 2.0 | 1.5 | 2.0 | 3.1 | 18.5 | 26.2 | 13.6 | 0.1 | 0.03 | 67.70 | 1.93 |
| Example 4 | 2.4 | 19.6 | 9.2 | 2.0 | 1.3 | 2.0 | 3.2 | 19.5 | 26.2 | 13.6 | 0.1 | 0.03 | 68.50 | 1.93 |
| Example 5 | 0.3 | 12.2 | 14.4 | 0.8 | 1.4 | 4.8 | 2.0 | 12.4 | 27.9 | 19.0 | 0.02 | 0.04 | 73.70 | 1.47 |
| Example 6 | 0.7 | 18.2 | 9.2 | 1.9 | 1.4 | 2.0 | 3.2 | 17.4 | 27.4 | 13.9 | 01 | 0.04 | 67.90 | 1.97 |
| Example 8 | 0.7 | 17.4 | 11.3 | 1.6 | 1.1 | 2.1 | 3.9 | 17.6 | 20.1 | 26.0 | 0.2 | 0.08 | 75.00 | 0.77 |
| Example 9 | 1.2 | 19.6 | 9.4 | 2.0 | 1.3 | 2.0 | 3.1 | 17.5 | 26.2 | 13.6 | 0.1 | 0.03 | 66.70 | 1.93 |

TABLE 2

| | Component composition (mass %) | | | | | | | | | | | | | |
|---|---|---|---|---|---|---|---|---|---|---|---|---|---|---|
| | | | | | | | | | | | | | MgO + SiO₂ + | Al₂O₃/ |
| | CaO | CaF₂ | MgO | Na₂O | K₂O | MnO | FeO | SiO₂ | Al₂O₃ | TiO₂ | ZrO₂ | B₂O₃ | Al₂O₃ + TiO₂ | TiO₂ |
| Comparative Example 1 | 0.3 | 12.2 | 17.9 | 0.7 | 1.4 | 4.8 | 2.0 | 13.9 | 18.2 | 19.0 | 0.02 | 0.05 | 69.00 | 0.96 |
| Comparative Example 2 | 2.8 | 10.1 | 4.8 | 2.7 | 0.7 | 2.6 | 5.0 | 18.6 | 26.2 | 13.8 | 0.1 | 0.15 | 63.40 | 1.90 |
| Comparative Example 3 | 0.3 | 18.5 | 9.4 | 2.1 | 1.3 | 2.2 | 4.0 | 21.3 | 27.5 | 15.0 | 0.2 | 0.12 | 73.20 | 1.83 |
| Comparative Example 4 | 0.3 | 12.2 | 14.3 | 0.6 | 1.6 | 4.8 | 2.0 | 8.4 | 27.2 | 14.5 | 0.02 | 0.06 | 64.40 | 1.88 |
| Comparative Example 5 | 0.3 | 18.9 | 9.6 | 2.2 | 1.4 | 2.1 | 3.1 | 19.8 | 30.0 | 15.7 | 0.2 | 0.13 | 75.10 | 1.91 |
| Comparative Example 6 | 0.2 | 18.2 | 11.1 | 2.1 | 1.3 | 2.3 | 4.2 | 19.6 | 11.5 | 21.1 | 0.2 | 0.12 | 63.30 | 0.55 |
| Comparative Example 7 | 2.8 | 15.3 | 8.8 | 2.5 | 0.4 | 1.5 | 4.6 | 15.0 | 21.1 | 29.3 | 1.0 | 0.09 | 74.20 | 0.72 |
| Comparative Example 8 | 2.3 | 14.7 | 9.8 | 2.8 | 0.7 | 2.6 | 4.6 | 18.6 | 21.2 | 11.8 | 0.1 | 0.19 | 61.40 | 1.80 |
| Comparative Example 9 | 0.7 | 12.5 | 11.0 | 3.0 | 0.9 | 3.6 | 5.0 | 19.7 | 27.5 | 23.0 | 0.03 | 0.57 | 81.20 | 1.20 |
| Comparative Example 10 | 2.9 | 11.0 | 9.5 | 2.2 | 1.3 | 1.6 | 3.7 | 12.2 | 18.6 | 14.7 | 1.0 | 0.1 | 55.00 | 1.27 |
| Comparative Example 11 | 2.4 | 19.6 | 9.4 | 2.0 | 1.3 | 2.0 | 3.1 | 19.5 | 27.8 | 13.2 | 0.1 | 0.03 | 69.90 | 2 11 |
| Comparative Example 12 | 2.8 | 10.3 | 9.5 | 3.5 | 0.4 | 1.6 | 4.5 | 18.6 | 13.2 | 27.8 | 1.0 | 0.09 | 69.10 | 0.47 |
| Comparative Example 13 | 0.7 | 12.5 | 9.0 | 2.4 | 0.9 | 3.6 | 6.8 | 19.7 | 27.5 | 16.5 | 0.03 | 0.18 | 72.70 | 1.67 |
| Comparative Example 14 | 0.3 | 12.2 | 14.9 | 0.7 | 1.4 | 4.6 | 0.3 | 13.9 | 18.5 | 18.5 | 0.02 | 0.10 | 65.80 | 1.00 |
| Comparative Example 15 | 0.4 | 15.6 | 11.3 | 2.0 | 1.2 | 8.7 | 3.4 | 18.4 | 26.6 | 17.3 | 0.2 | 0.13 | 73.60 | 1.54 |
| Comparative Example 16 | 2.8 | 15.3 | 10.8 | 2.8 | 0.6 | 1.2 | 2.5 | 16.5 | 21.1 | 17.7 | 1.8 | 0.09 | 66.10 | 1.19 |
| Comparative Example 17 | 0.5 | 23.68 | 8.4 | 2.2 | 1.3 | 5.6 | 3.1 | 19.8 | 27.3 | 15.5 | 1.8 | 0.01 | 71.00 | 1.76 |
| Comparative Example 18 | 2.3 | 5.5 | 9.5 | 2.4 | 1 | 1.6 | 4.8 | 16 | 21.5 | 27.7 | 0.9 | 0.03 | 74.70 | 0.78 |
| Comparative Example 19 | 0.4 | 16.5 | 13.4 | 0.9 | 0.6 | 2.1 | 3.9 | 16.5 | 20.7 | 20.1 | 0.2 | 0.10 | 70.70 | 1.03 |

TABLE 3

| | Evaluation items | | | | | |
|---|---|---|---|---|---|---|
| | Bead | | Slag | | Low- | |
| | appear- | Bead | remov- | Porosity | temperature | |
| | ance | shape | ability | defect | toughness | |
| Example 1 | ∘ | ∘ | ∘ | ∘ | ∘ | 77 |
| Example 2 | ∘ | ∘ | ∘ | ∘ | ∘ | 80 |
| Example 3 | ∘ | ∘ | ∘ | ∘ | ∘ | 64 |
| Example 4 | ∘ | ∘ | ∘ | ∘ | ∘ | 64 |
| Example 5 | ∘ | ∘ | ∘ | ∘ | ∘ | 82 |
| Example 6 | ∘ | ∘ | ∘ | ∘ | ∘ | 69 |
| Example 8 | ∘ | ∘ | ∘ | ∘ | ∘ | 59 |
| Example 9 | ∘ | ∘ | ∘ | ∘ | ∘ | 53 |

TABLE 4

| | Evaluation items | | | | | |
|---|---|---|---|---|---|---|
| | Bead | | Slag | | Low- | |
| | appear- | Bead | remov- | Porosity | temperature | |
| | appeance | shape | ability | defect | toughness | |
| Comparative | ∘ | x | Δ | Δ | ∘ | 50 |
| Example 1 | | | | | | |
| Comparative | ∘ | ∘ | Δ | ∘ | ∘ | 64 |
| Example 2 | | | | | | |
| Comparative | ∘ | x | ∘ | ∘ | ∘ | 94 |
| Example 3 | | | | | | |
| Comparative | Δ | ∘ | Δ | Δ | ∘ | 51 |
| Example 4 | | | | | | |
| Comparative | x | ∘ | Δ | ∘ | ∘ | 76 |
| Example 5 | | | | | | |
| Comparative | Δ | x | ∘ | Δ | Δ | 31 |
| Example 6 | | | | | | |
| Comparative | x | ∘ | Δ | ∘ | ∘ | 58 |
| Example 7 | | | | | | |
| Comparative | Δ | x | Δ | Δ | Δ | 35 |
| Example 8 | | | | | | |
| Comparative | ∘ | x | Δ | ∘ | Δ | 41 |
| Example 9 | | | | | | |
| Comparative | x | ∘ | x | Δ | x | 20 |
| Example 10 | | | | | | |
| Comparative | ∘ | ∘ | x | ∘ | ∘ | 64 |
| Example 11 | | | | | | |
| Comparative | Δ | ∘ | Δ | Δ | x | 25 |
| Example 12 | | | | | | |
| Comparative | ∘ | x | Δ | x | Δ | 41 |
| Example 13 | | | | | | |
| Comparative | ∘ | x | Δ | ∘ | x | 25 |
| Example 14 | | | | | | |
| Comparative | ∘ | x | Δ | ∘ | Δ | 46 |
| Example 15 | | | | | | |
| Comparative | ∘ | ∘ | x | Δ | x | 25 |
| Example 16 | | | | | | |
| Comparative | Δ | ∘ | ∘ | Δ | ∘ | 59 |
| Example 17 | | | | | | |
| Comparative | ∘ | ∘ | Δ | ∘ | Δ | 40 |
| Example 18 | | | | | | |
| Comparative | Δ | ∘ | ∘ | ∘ | ∘ | 64 |
| Example 19 | | | | | | |

From the above results, in the high speed submerged arc welding using the flux in the present embodiment, good results were obtained in any of the bead appearance, the bead shape, the slag removability, the porosity defect resistance, and the low-temperature toughness.

On the other hand, in the case where the content of MgO was excess, the bead shape, the slag removability and the porosity defect resistance were inferior, and in the case where the content of MgO was too small, the slag removability deteriorated. In the case where the content of SiO₂ was excess, the bead shape deteriorated, and in the case where the content of SiO₂ was too small, the bead appearance, the slag removability, and the porosity defect deteriorated. In the case where the content of Al₂O₃ was excess, the bead appearance and the slag removability deteriorated, and in the case where the content of Al₂O₃ was too small, the bead appearance, the bead shape, the porosity defect resistance, and the low-temperature toughness deteriorated. In the case where the content of TiO₂ was excess, the bead appearance and the slag removability deteriorated, and in the case where the content of TiO₂ was too small, all of the bead appearance, the bead shape, the slag removability, the porosity defect resistance, and the low-temperature toughness deteriorated. In the case where the total content of (MgO+SiO₂+Al₂O₃+TiO₂) was excess, the bead shape, the slag removability, and the low-temperature toughness deteriorated, and in the case where the total content of (MgO+SiO₂+Al₂O₃+TiO₂) was too small, the bead appearance, the slag removability, the porosity defect resistance, and the low-temperature toughness deteriorated. In the case where the ratio of the content of Al₂O₃ to the content of TiO₂, i.e. Al₂O₃/TiO₂, was more than 2.0, the slag removability deteriorated, and in the case where the ratio was less than 0.5, the bead appearance, the slag removability, the porosity defect resistance, and the low-temperature toughness deteriorated.

In the case where the content of FeO was excess, the bead shape, the slag removability, the porosity defect resistance, and the low-temperature toughness deteriorated, and in the case where the content of FeO was too small, the bead shape, the slag removability, and the low-temperature toughness deteriorated. In the case where the content of MnO was excess, the bead shape, the slag removability, and the low-temperature toughness deteriorated, and in the case where the content of MnO was too small, the slag removability, the porosity defect resistance, and the low-temperature toughness deteriorated. In the case where the content of CaF₂ was excess, the bead appearance and the porosity defect resistance deteriorated, and in the case where the content of CaF₂ was too small, the slag removability and the low-temperature toughness deteriorated. In the case where the total content of Na₂O and K₂O was excess, the bead appearance deteriorated, and in the case where the total content of Na₂O and K₂O was too small, the bead shape deteriorated.

Although the present invention is described in detail with reference to specific embodiments, it is apparent to those skilled in the art that various alterations and modifications are possible without departing from the spirit and scope of the present invention. The present application is based on Japanese Patent Application No. 2018-64990 filed on Mar. 29, 2018, the entire contents of which are incorporated herein by reference. All references cited herein are entirely incorporated.

1. A flux for submerged arc welding, which is a sintered flux,
wherein the following relationships of contents in mass percent are satisfied:
CaF₂: 10.0% to 20.0%;
MgO: 8.0% to 15.0%;
a sum of Na₂O and K₂O: 2.1% to 3.5%;
MnO: 1.5% to 5.0%;
FeO: 0.5% to 5.0%;
SiO₂: 10.0% to 20.0%;
Al₂O₃: 13.0% to 28.0%; and
TiO₂: 13.0% to 28.0%, and
the following relationships are further satisfied:
65≤(MgO+SiO₂+Al₂O₃+TiO₂)≤75; and
0.5≤(Al₂O₃/TiO₂)≤2.0.

2. The flux for submerged arc welding according to claim 1, wherein at least one of the following relationships of contents in mass percent is further satisfied:
CaO: 0.2% to 3.0%;
ZrO₂: 5.0% or less (including 0%); and
B₂O₃: 0.03% to 0.15%.

3. The flux for submerged arc welding according to claim 1, which is a high-temperature sintered flux sintered at 700° C. to 1200° C.

4. The flux for submerged arc welding according to claim 2, which is a high-temperature sintered flux sintered at 700° C. to 1200° C.
